(19) United States
(12) Patent Application Publication
(10) Pub. No.: US 2016/0071209 A1
(43) Pub. Date: Mar. 10, 2016

(54) SYSTEM AND COMPUTER PROGRAM PRODUCT FOR MANAGING CROWD FUNDING

(71) Applicants: Bobby Katoli, Dallas, TX (US); Jonathan Startz, Dallas, TX (US)

(72) Inventors: Bobby Katoli, Dallas, TX (US); Jonathan Startz, Dallas, TX (US)

(73) Assignee: Mass Catalyst Corporation, Arlington, TX (US)

(21) Appl. No.: 14/479,327

(22) Filed: Sep. 7, 2014

(51) Int. Cl. G06Q 40/04; G06Q 50/00

(52) U.S. Cl. CPC G06Q 40/04; G06Q 50/01

(57) ABSTRACT

A system and computer program product for managing crowd funding. The system includes a plurality of remote computers respectively operated by a plurality of users, a shared database in communication with a central server configured to receive and verify a request for a plurality of crowd related funding, store the information for each of the plurality of crowd related funding in the shared database, provide a listing for each of the plurality of crowd related funding from the shared database on at least one of the plurality of remote computers, receive one or more funding bids for at least one of the plurality of crowd related funding from one or more crowd members during a predefined period, and calculate a funding amount based on the one or more funding bids.

### BACKGROUND OF THE INVENTION

1. Field of the Invention

The present invention is generally related to crowd related funding, and more particularly to a system and computer program product for managing crowd funding.

2. Discussion of the Background

Crowdfunding is the practice of obtaining needed funding by soliciting contributions from a large group of people, and especially from an online community.

Problems and deficiencies associated with providing and managing crowd funding exist in the prior art. In particular, the prior art is lacking in other new and novel crowd functionality relating to equity, debt and convertible debt crowdfunding. Thus, there currently exist deficiencies associated with crowd funding, and, in particular, with managing crowd funding.

### SUMMARY OF THE INVENTION

Accordingly, one aspect of the present invention is to provide a system for managing crowd funding. The system includes a plurality of remote computers respectively operated by a plurality of users, a central server, a network interface in communication with the central server and the plurality of remote computers over a network, and a shared database in communication with the central server. The network interface is configured to provide crowd related funding. The central server is configured to receive and verify a request for a plurality of crowd related funding, store the information for each of the plurality of crowd related funding in the shared database, provide a listing for each of the plurality of crowd related funding from the shared database on at least one of the plurality of remote computers, receive one or more funding bids for at least one of the plurality of crowd related funding from one or more crowd members during a predefined period, and calculate a funding amount based on the one or more funding bids.

Another aspect of the present invention is to provide a computer program product embodied on a non-transitory computer readable medium for managing crowd funding. The computer program is implemented by one or more processors executing processor instructions. The computer program product includes a first computer code for receiving and verifying on a central server a request for a plurality of crowd related funding, a second computer code for storing the information for each of the plurality of crowd related funding in a shared database in communication with the central server, a third computer code for providing a listing for each of the plurality of crowd related funding from the shared database on at least one of a plurality of remote computers respectively operated by a plurality of users, a fourth computer code for receiving one or more funding bids for at least one of the plurality of crowd related funding from one or more crowd members during a predefined period, and a fifth computer code for calculating a funding amount based on the one or more funding bids.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1G are block diagrams illustrating a system for managing crowd funding in accordance with an embodiment of the present invention;

FIGS. 2A-2I are flow charts illustrating a method for managing crowd funding in accordance with an embodiment of the present invention; and

FIGS. 3A-3H illustrate exemplary user interfaces for managing crowd funding in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

While investing in stock in large companies is vital for the financial markets, it is the investment in small businesses and innovative ideas that truly propels companies forward. Although not limited to small businesses, the present invention relates to an equity, debt and convertible debt crowdfunding platform that enables entrepreneurs to raise money using a novel model that creates a true equity, debt and convertible debt crowdfunding marketplace for businesses and investors.

### Equity Auction

According to the present invention, an equity auction is an online auction in which a company, entity, organization or project (herein “business entity”) desires to get funding in exchange for equity. The equity auction may or may not have a minimum bid. According to one embodiment, the equity auction has a minimum bid set by a third party valuation services firm. For example, if a third party valuation services values the price per share at $1, then that may be used as the starting bid.

According to another embodiment, the equity auction has no minimum bid and investors can start the auction at whatever price they choose. This gives investors the ability to start the auction at any price they choose. For example, investors could start bidding at $0.01, $0.05, etc. However, according to one embodiment, for a no minimum bid auction, investors must bid up to the value determined by a third party for the business entity to reach its funding goal. If the business entity doesn't reach its funding goal, the business entity may elect to terminate the auction or to issue more shares. For example, if investors only bid to $0.80, then the business entity did not reach their goal. The business entity may elect to either give up on the auction or issue more shares.

As another example, a business entity may want to raise $100,000 in funding and issue 100,000 shares for a value of $1 per share ($100,000/100,000 shares). The present invention may either utilize a minimum per share value as a minimum bid, or may have no minimum and let investors start the bidding at a price they choose, such as $0.01. Where there is no minimum bid, if the final bid does not reach $1 or greater then the business entity did not reach their goal. For instance, if the final bid reaches $0.80 by the end of auction, then the business entity only reached $80,000 ($0.80*100,000) out of its $100,000 goal. Using the present invention, the business entity may elect to either quit the auction or to issue more shares and continue the auction. If the business entity elects to continue the auction, it can either issue more shares at the current price ($0.80) to winning investors or start a new auction with the new shares. At $0.80 a share, the business entity would need to issue 25,000 shares (($100,000−$80,000)/0.80) to reach its funding goal. The new shares could be used to (i) start a new auction altogether using a new starting bid, (ii) continue the auction at the current bid ($0.80), or (iii) the 25,000 shares could be sold at the winning bid ($0.80) to all winning investors only. If bidding continues at the current price of $0.80, then the system calculates additional shares for all investors regardless if they are winning or losing investors.

If the shares are sold to the winning investors, then the highest bidder in the auction gets the option to purchase the additional 25,000 shares at the winning price of $0.80. Whatever number of shares remain after the highest bidders purchase, the second investor gets the option to purchase the leftover shares, if there are any, at $0.80. The third highest investor gets the option to purchase shares any leftover shares remaining at $0.80. This process continues until all the shares are bought by the winning investors or the business entity does not reach its funding goal.

As another example, a business entity may want to raise $50,000 in funding in exchange for 50,000 shares. The price per share might initially start at a bid rate of $1.00 per share at start of the auction. The investors would use the present invention to place the amount they wish to invest along with their bid on the price per share. If investor bids at rate of $1.00 shares and wants to invest $1,000, then investor1 wants to buy 1,000 shares at a rate of $1.00 per share. The business entity would then have only $49,000 to raise in funding before it reaches its funding goal and only 49,000 shares left for other potential investor. If investor2 bids on the remaining 49,000 shares at a bid rate of $1.00, the business entity has reached its funding goal and all shares have been bid on. Since all of the shares have been bid on at a rate of $1.00 per share, if investor3 wants to bid on additional shares, then the present invention requires investor3 to bid at a higher price than $1.00. If investor3 bids $1.01 per share and wants to invest $5,000,then investor3 wants to buy 4,951 shares at the rate of $1.01 per share. Investor2, who bid $1.00 for 49,000, would be pro-rated by the present invention, meaning that investor2 would only receive 44,049 (49,000−4,951) shares because of investor3 (essentially, early investors have greater protection due to seniority and keep their shares longer). If the auction were to end right at this point, then the present invention would calculate that the investor1 would receive 1,000 shares at a rate of $1.00 per share, investor2 would receive 49,049 shares at a rate of $1.00 per share, and investor3 would receive 4,951 shares at a rate of $1.01 per share. According to this embodiment, priority of the auction is based on the price, date, and time. In the above example, investor2 was pro-rated due to time of the bid since investor2 was the second bidder after the first bidder.

According to the present invention, the final price that all investors pay is the lowest winning bid. In the above three-investor scenario, all of the investors won shares in the business entity, but investor1 bid the lowest bid rate of $1.00 per share. Since $1.00 was the lowest winning bid, then the present invention would use the lowest winning bid of $1.00 per share as the price that all “winning” investors pay. If bidding continued, the minimum winning bid would be higher, for example, at $5.00 per share. As the minimum winning bid increases, the business entity has effectively raised more money than they initially were seeking for the same number of shares. Alternatively, the business entity could raise the originally desired amount (in this example $50,000) and issue fewer shares, or anything in between (overfunded for less but also issues fewer shares. For instance, the business entity might raise $60,000 for 40,000 shares instead of $75,000 for 50,000 shares).

In an alternate embodiment, the present invention allows investors to bid down the price per share and give the business entity the option to release a larger number of shares in order to get funded. Federal law requires that business entities meet their original funding target or the funding raising process is considered to have failed and all money must be returned to the investors.

### Crowd Funding Functionality

Case 1: Assume that (i) business entity A is an entity sharing 5,000 shares and bid rate $1 per stock, (ii) investor1 has bid 1,000 shares at the bid rate of $1 per share, (iii) investor2 has bid 2,000 shares at the bid rate of $1 per share, (iv) investor3 has bid 3,000 shares at the bid rate of $1 per share, and that (v) the auction is coming to an end. In this scenario, all the winning investors are winning and final winning rate is $1 per share.

Case 2: Assume that (i) business entity A is an entity sharing 5,000 shares and bid rate $1 per stock, (ii) investor1 has bid 1,000 shares at the bid rate of $1 per share, (iii) investor2 has bid the remaining 4,000 shares at the bid rate of $1 per share, (iv) investor3 has bid 1,000 shares at the bid rate of $1.01 per share (according to the present invention, the investor is required to bid the shares with increased bid rate (e.g., $1.01) because the shares are already sold out), and that (v) the auction is coming to an end. In this scenario, investor1 will win with the bid of 1,000 shares, investor2 will win with the bid of 3,000 (4,000−1,000) shares, and investor3 will win with the bid of 1,000 shares, with all investors paying a rate of $1.00 per share.

Case 3: Assume that (i) business entity A is an entity sharing 5,000 shares and bid rate $1 per stock, (ii) investor1 has bid 5,000 shares at the bid rate of $1 per share, (iii) investor2 has bid 3,000 shares at the bid rate of $1.01 per share (according to the present invention, the investor is required to bid the shares with increased bid rate (e.g., $1.01) because the shares are already sold out), and (iv) investor3 has bid 3,000 shares at the bid rate of $1.05 per share, and that (v) the auction is coming to an end. In this scenario, investor2 will win with the bid of 3,000 (5,000−2,000) shares with the bid rate of $1.01 per share, investor3 will win 2,000 shares in the bid rate of $1.05, investor1 will not get anything, and all winning investors pay a rate of $1.01 per share.

### Auction Displacement

According to an alternate embodiment, the equity auction may include a displacement compensation for the original investors (investors that invest up to the original funding goal). For example, a business entity may want to raise $50,000 in funding in exchange for 50,000 shares. If investor1 and investor2 each bid 25,000 shares, then these investors would be the original investors. If investor3 bids 25,000 shares, then investor3 would displace investor2 . Since investor2 was part of the original investors who bid on the shares, then according to this embodiment, investor2 would receive a monetary compensation of a predetermined percentage of the over funded amount. For instance, if, at the end of the auction, the business entity surpasses its funding target of $50,000 by raising $75,000, then all the displaced original investors would be entitled to a predetermined percentage (e.g., 25%) of the over funded amount ($25,000×25%) split evenly among all of the original displaced investors. Thereby the present invention would create an incentive for investors to bid early and bid on all of the shares for the business entity to reach its initial funding target.

### Debt Auction

The business entity can choose between equity and/or debt funds. For a debt-based auction, the investors bid on the interest rate they are willing to accept. According to the present invention, a debt auction is an online auction in which a business entity desires to get funding as a loan with an interest rate. The debt auction may or may not have a maximum interest rate bid. According to one embodiment, the debt auction has no maximum bid. For example, if a third party valuation services issues an opinion that the business entity debt should be an interest rate of 15%, then the present invention would allow investors to bid an interest rate higher than 15% (e.g., at 30% or 40%, etc). According to an alternate embodiment, the debt auction has a maximum bid. For example, if a third party valuation services issues an opinion that the business entity debt should be an interest rate of 15%, then the present invention investors would not allow investor to bid more than 15%. They must bid an interest rate of 15% or lower.

According to another embodiment, the present invention calculates the interest for all winning investors based on the highest winning interest rate bid at the end of debt auction. Alternatively, the present invention calculates the interest for each winning investor based on their respective interest rates bids during the auction. According to this embodiment, there is basically no highest winning bid. The winning investors will pay what they bid, with no uniform highest winning bid that all investors pay. According to yet another embodiment, the present invention calculates the interest for all winning investors based a weighted average. According to this embodiment, each of the winning investors would pay a weighted average of the winning bids.

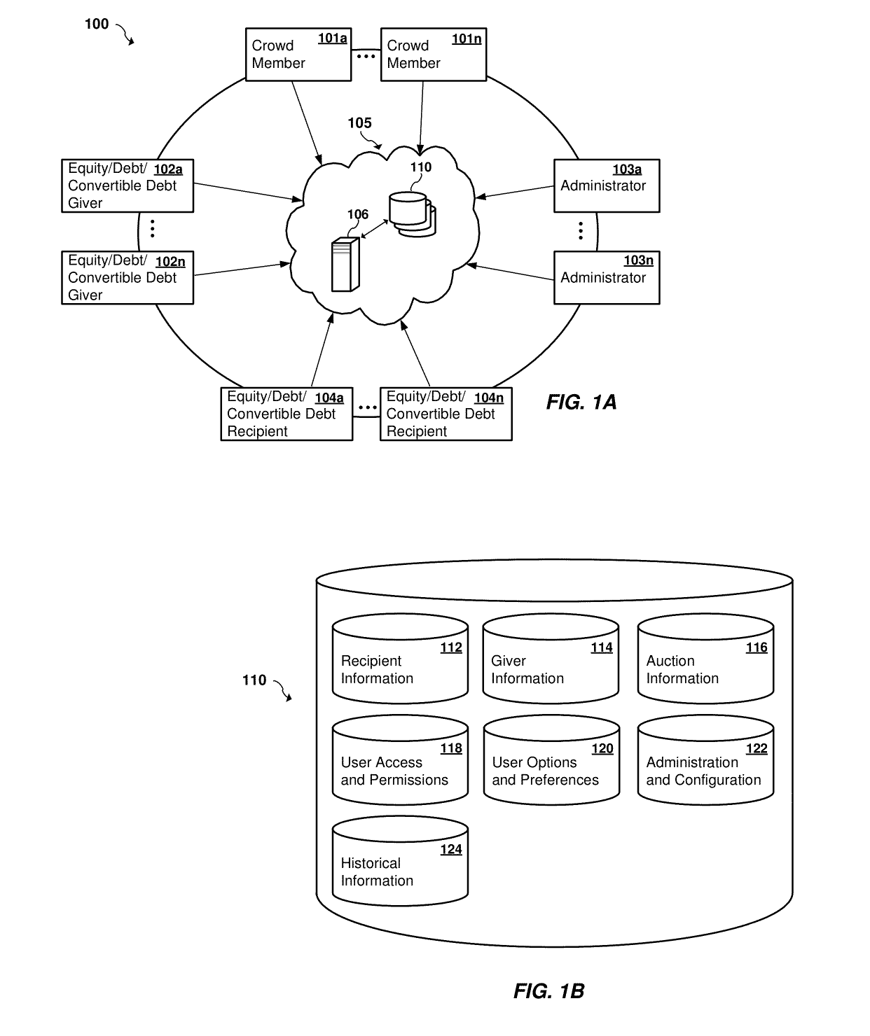

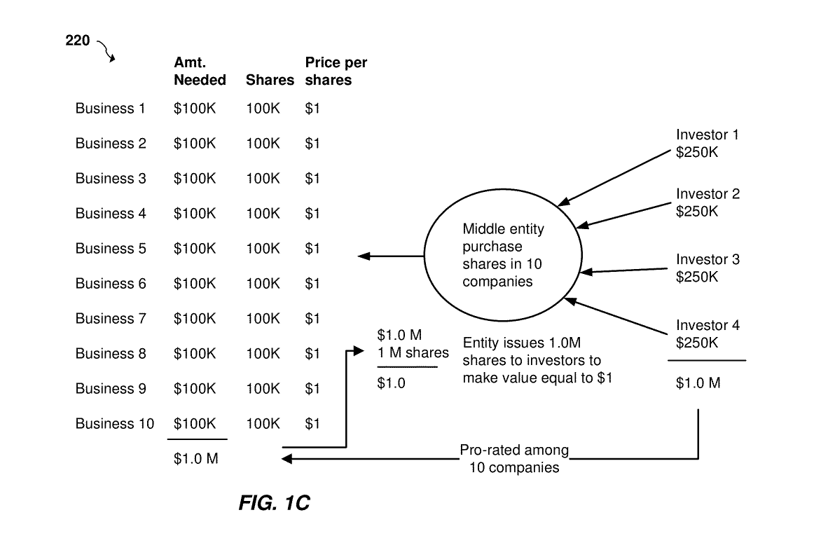

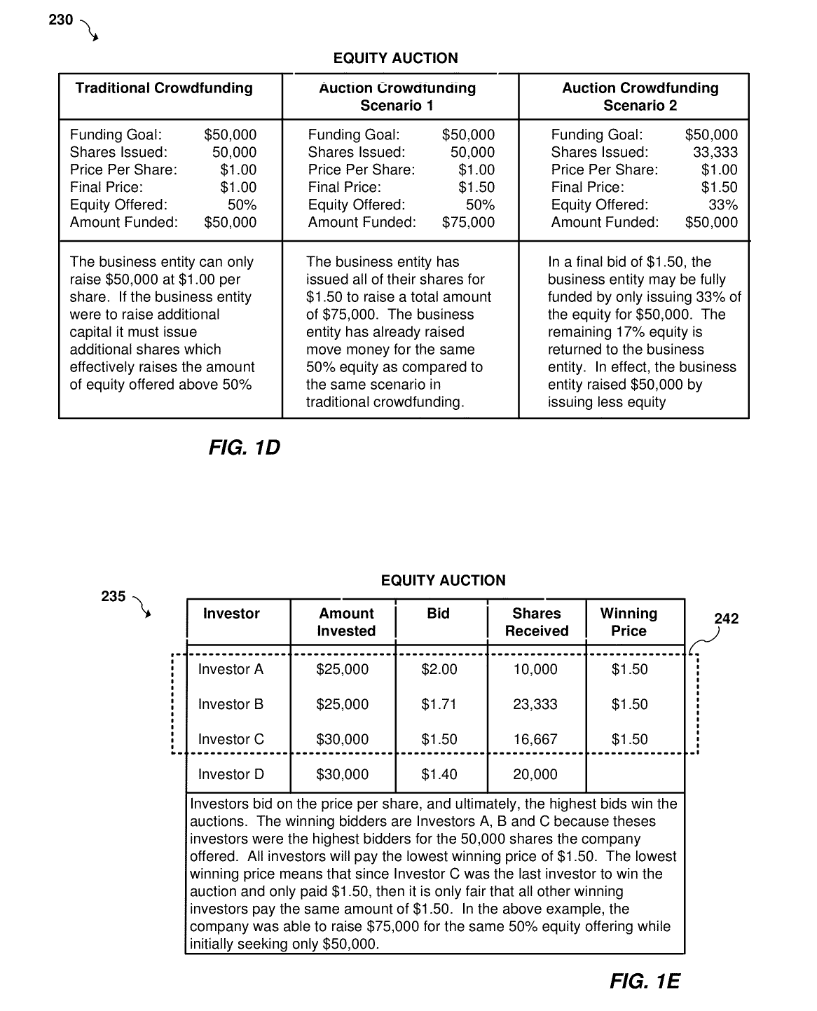

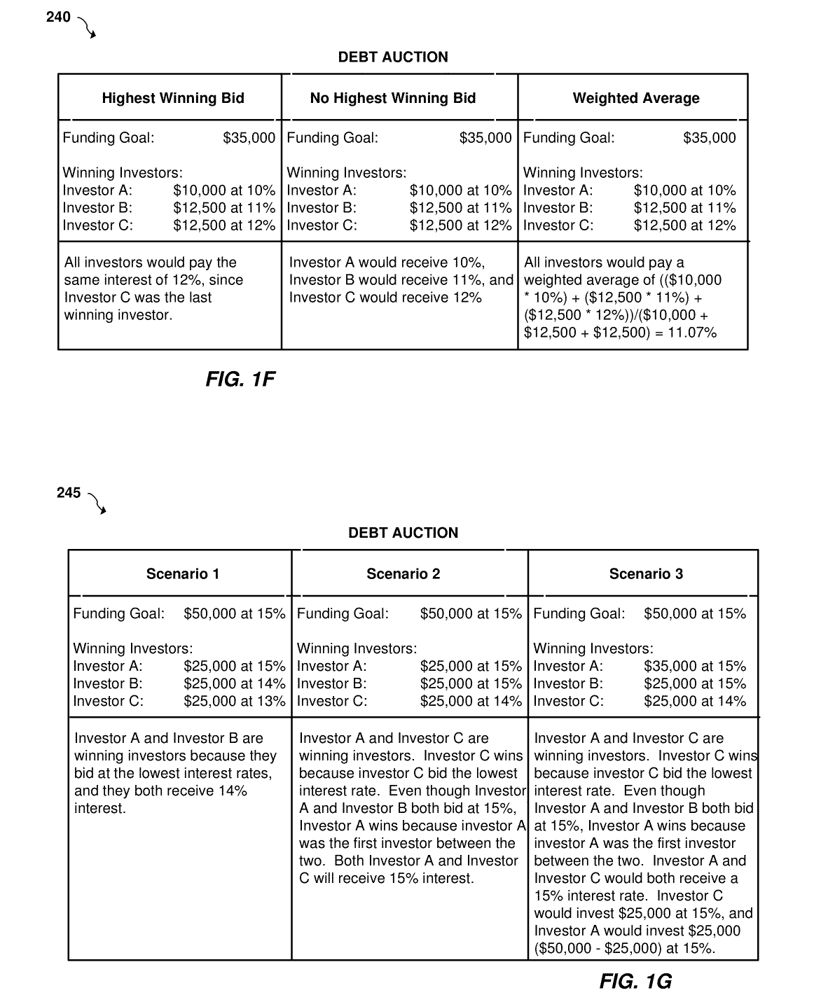

In the debt auction there will NOT be a per share amount. Referring to the three exemplary scenarios shown in FIG. 1G, a business entity wants to borrow $50,000 for one year. After a third party evaluates the business entity, they determine the starting interest rate should be 15%. In other words, the business entity is looking to borrow $50,000 and pay an interest rate of 15% to investors over the one year period.

According to scenario 1, investor 1 bids $25,000 at an interest rate of 15%, investor 2 bids $25,000 at an interest rate of 14%, and investor 3 bids $25,000 at an interest rate of 13%. Investor A and Investor B are winning investors because they bid at the lowest interest rates, and they both receive 14% interest.

According to scenario 2, investor 1 bids $25,000 at an interest rate of 15%, investor 2 bids $25,000 at an interest rate of 15%, and investor 3 bids $25,000 at an interest rate of 14%. Investor A and investor C are winning investors. Investor C wins because investor C bid the lowest interest rate. Even though investor A and investor B both bid at 15%, investor A wins because investor A was the first investor between the two. Both investor A and investor C will receive an interest rate of 15%.

According to scenario 3, investor 1 bids $35,000 at an interest rate of 15%, investor 2 bids $25,000 at an interest rate of 15%, and investor 3 bids $25,000 at an interest rate of 14%. Investor A and investor C are winning investors. Investor C wins because investor C bid the lowest interest rate. Even though investor A and investor B both bid an interest rate of 15%, investor A wins because investor A was the first investor between the two. Investor A and investor C would both receive an interest rate of 15%. Investor C would invest $25,000 at 15%, and investor A would invest $25,000 ($50,000−$25,000) at an interest rate of 15%.

### Convertible Debt Auction

According to the present invention, a convertible debt auction is an online auction in which a business entity desires to get funding in exchange for equity and a loan with an interest rate. With regards to a startup business entity, the convertible debt is used as a bridge loan until the next financing round. For example, if a business entity is going to raise 1 million dollars from a venture capital firm in a few months, the business entity might be interested in issuing convertible debt to give itself capital so it doesn't run out of cash in the meantime. Convertible debt has features that make it both a loan and equity. The benefit for both the business entity and any potential inventors is that they don't have to negotiate a value of the business entity for stock purchase.

Under a convertible debt auction, investors are giving money in exchange for interest payments. This is the loan aspect of the convertible debt. In addition, the convertible debt owner will receive stock in the business entity at the next financing round. Continuing from our example above, if the business entity were to raise one million dollars from the venture capital firm, the convertible debt owner might be entitled to a discount to what the value of the business entity is at that time in the future. For example, in the next few months at the next financing round, the business entity is issuing shares at $1 per share. The convertible debt owner may purchase shares at a 20% discount, thus allowing the convertible debt owner to purchase the business entity shares at $0.80 instead of $1 per share. This is the equity aspect of the convertible debt.

Thus, according to one embodiment of the present invention, there are two main components of a convertible debt auction: the interest payments and a discount to the next valuation. The interest rate determines the interest payments investors will receive until the maturity of the debt. The discount determines what price the investor will receive at the next valuation (e.g., $0.80 per share).

According to an alternate embodiment, a convertible debt auction might work in three ways. The present invention might allow investors may have a reverse auction (like a debt auction) on (i) the interest and a discount rate, (ii) the interest rate only, or (iii) the discount only. If the convertible debt auction is both an interest rate and a discount, the user inputs both variables and the combined lowest value will win the auction. The combined lowest value means the lowest total rate of return the investor will receive based on the two variables of interest rate and discount. Again, the interest rate determines the interest payments investors will receive from the loan. The discount is the price investors will at the next valuation of the business (e.g., $0.80 per share). In other words, just as in the debt auction, the investors begin bid the interest rates and discounts down, and ultimately the lowest rates of return win. If the auction is based on the interest rate only, then the discount is fixed, and investors bid on the interest rates, and the lowest interest rates win the auction. If the auction is based on the discount, then the interest is fixed, and the lowest discounts win the auction.

The starting bid of either the interest or discount could be either based on a third party valuation or there could be no starting bid. If the starting bid is based on a third party valuation, then the bid can never be higher than the valuation. If there is no starting maximum bid, then the investors begin bidding at whatever interest and/or discount they choose depending on the auction type (an interest rate and a discount, an interest rate only, or a discount rate only).

### Mutual Fund/Syndicate/Securitization

Referring to the example shown in FIG. 1C, according to one embodiment, business entities are grouped together, as a package deal, and investors invest in the overall package. For example, instead of bidding $1 on one business entity, the present invention groups 10 business entities together and investors bid $1, for effectively 10 companies. This helps to diversify investor risk and increases the probability for companies to receive funding. Investors would be more willing to pay $1 for ten business entities ($0.10 per business entity) rather than $1 per business entity. Since investors would be more willing to purchase a package deal like this, the ten business entities have increased their probability of receiving money for their respective businesses. Basically, investors will bid on a middle entity that will purchase shares in 10 business entities.

For example, a middle entity might invest in 10 different business entities. The middle entity might purchase shares in 10 different business entities that have packaged together. If, in aggregate, these business entities wanted to raise $1.0 million total, $100,000 per business entity, the middle entity would purchase shares of the companies and give them $100,000 each. However, the middle entity needs funding from investors to purchase the 10-business entity package. Investors might bid on this middle entity that will essentially invest in 10 specific pre-determined business entities. The middle entity that would essentially purchase the shares of the 10 business entities. If the entity raises $1.0 million from investors then each business entity would receive its pro-rata portions of the money (in this case $100,000 each due to the equal amounts of each business entities). If the investors were to bid high enough and the business entities raises, for example, $1.5 million, then each business entity would receive $150,000 ($1,500,000/10 business entities).

### I. System for Managing Crowd Funding

Referring to FIGS. 1A-1B, block diagrams illustrating a system 100 for managing crowd funding in accordance with an embodiment of the present invention are shown. The system 100 includes one or more computers and/or servers 106 in communication with one or more databases 110. According to one embodiment, the one or more databases 110 include without limitation recipient information data 112, giver information 114, auction information data 116, user access and permissions data 118, user options and preferences data 120, administration and confirmation data 122, and historical information data 126. It is understood, however, that other databases and/or combinations thereof are possible within the scope of the present invention.

According to one embodiment, one or more crowd members (101a-101n), one or more equity, debt or convertible debt givers (102a-102n), one or more equity, debt or convertible debt recipients (104a-104n), and one or more administrators (103a-103n) may access the system 100 using an interface device via a network 105. The system may utilize, without limitation, a secure socket connection to a web server running on the system 100. The interface device may include without limitation a computer, tablet, laptop, PDA, smart phone, server, network device, and the like. The network 105 may include without limitation the Internet, Intranet, LAN, WAN, proprietary network, and the like. The one or more crowd members (101a-101n), one or more equity, debt or convertible debt givers (102a-102n), one or more equity, debt or convertible debt recipients (104a-104n), and/or one or more administrators (103a-103n) may utilize a web browser or other software and/or hardware to communicate with the system 100.

Each crowd member 101, equity, debt or convertible debt giver 102, equity, debt or convertible debt recipient 104, administrator 103, having the appropriate permission, has the ability to access the user interfaces and modules of the system 100, or portions thereof. A web-based graphic user interface allows the crowd member 101, equity, debt or convertible debt giver 102, equity, debt or convertible debt recipient 104, administrator 103 to access the user interfaces of the system 100 or portions thereof. According to an alternate embodiment, a crowd member 101, equity, debt or convertible debt giver 102, equity, debt or convertible debt recipient 104, administrator 103 accesses the user interfaces in a standalone configuration.

As used herein, a crowd member 101 is generally a web user, or said another way one of many (i.e., a crowd). A crowd member may be an individual, startup, business, group, entity, party, and the like. A crowd member 101 is typically provided access permission to the user interfaces and modules of the system 100 that allow the crowd member 101 to, without limitation, fund certain crowd businesses or people, projects, charities, or causes, and to configure options and preferences for that particular crowd member 101.

As used herein, an administrator 103 is a person who configures portions of the system 100. An administrator 103 is typically an employee of, or associated with, the entity hosting and/or maintaining the system 100 and is typically granted full permission to all user interfaces, modules, settings and configurations of the system 100. In addition to having access permission to the administrative user interfaces, modules, settings and configurations of the system 100 as described above, an administrator 103 will also typically be provided access permission to the user interfaces and modules of the system 100 that a crowd member 101, equity, debt or convertible debt giver 102, and/or equity, debt or convertible debt recipient 104 would have access.

The permission information and the user options and preferences may be stored using any means. The permissions information may identify different user interfaces of the system 100 and/or portions thereof to which the crowd member 101, equity, debt or convertible debt giver 102, equity, debt or convertible debt recipient 104, and/or administrator 103 have access. The permissions information may also identify different or modules/functionality of the system 100 or portions thereof that the crowd member 101, equity, debt or convertible debt giver 102, equity, debt or convertible debt recipient 104, and/or administrator 103 have access.

The present invention also provides a unique algorithm for determining funders and motivating funding as detailed herein.

The processing of the present invention involves the coordination of all of the above processes and automation of the website characteristics, including, without limitation, triggers, emails, blog and social media posts, event creation, map flag creation, and the like.

### II. Processing for Managing Crowd Funding

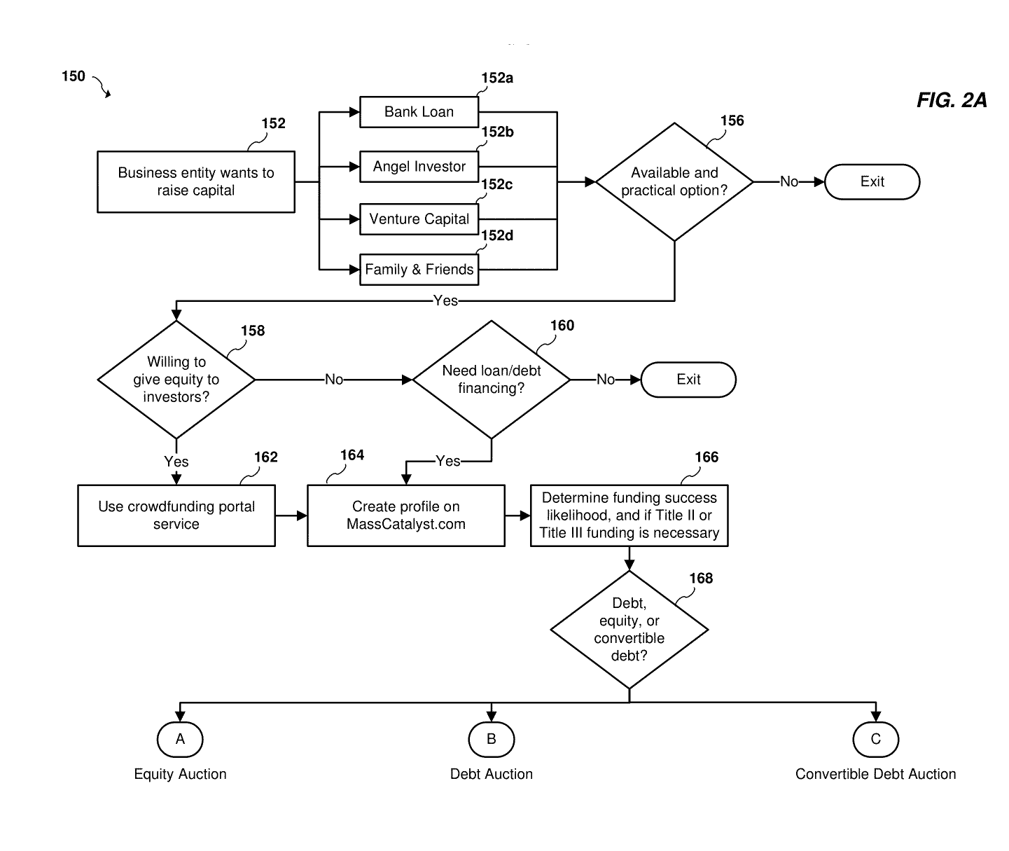

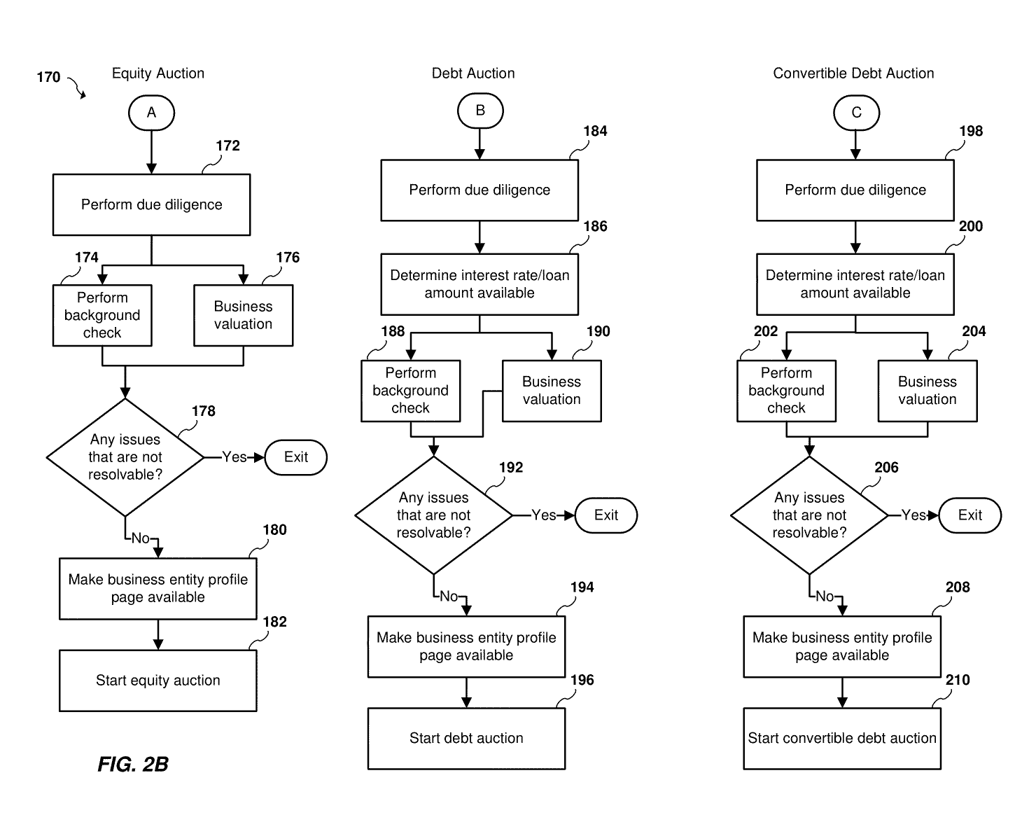

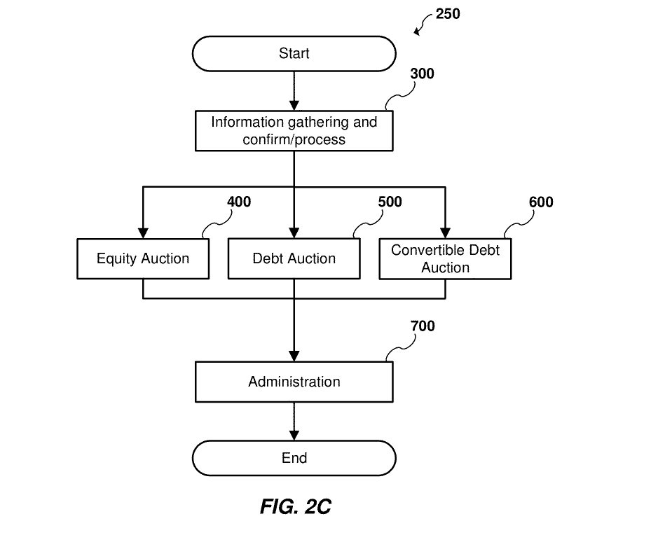

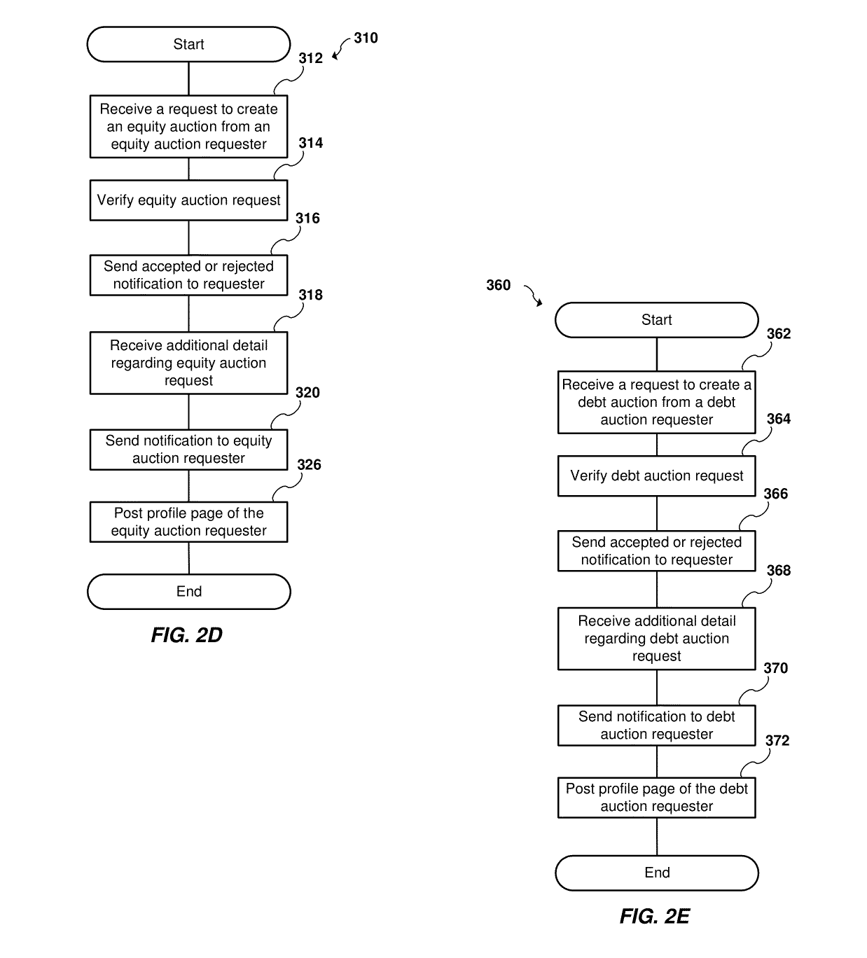

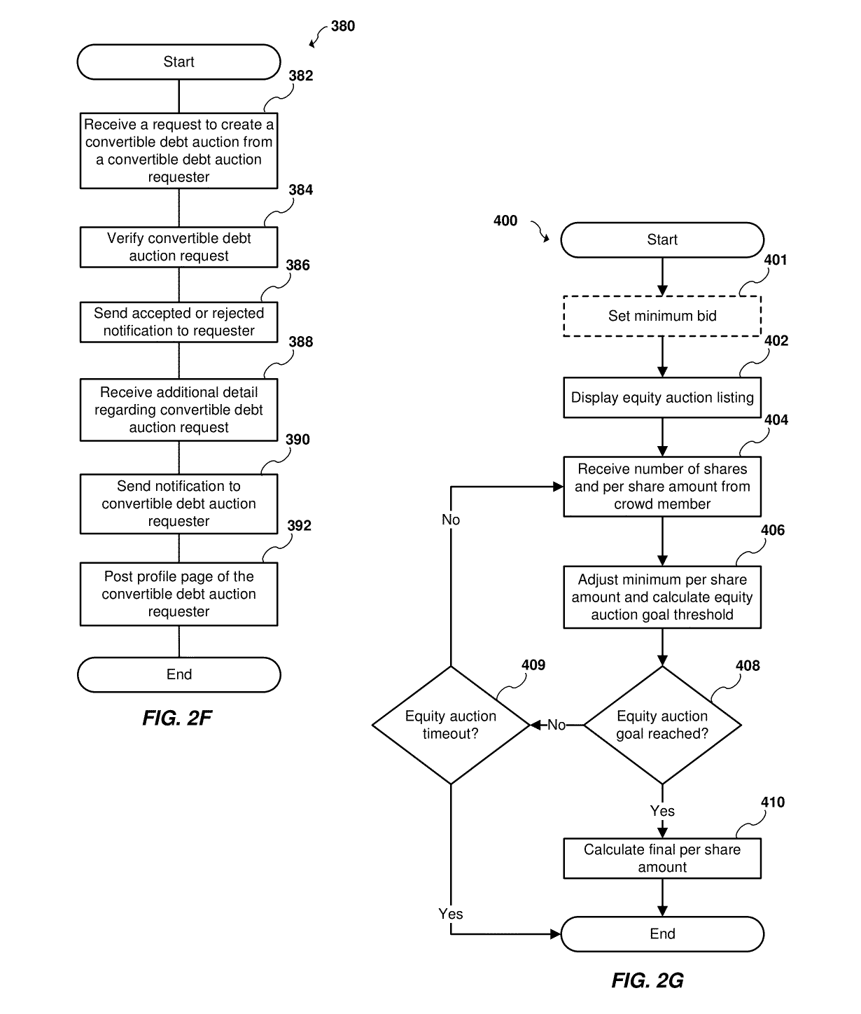

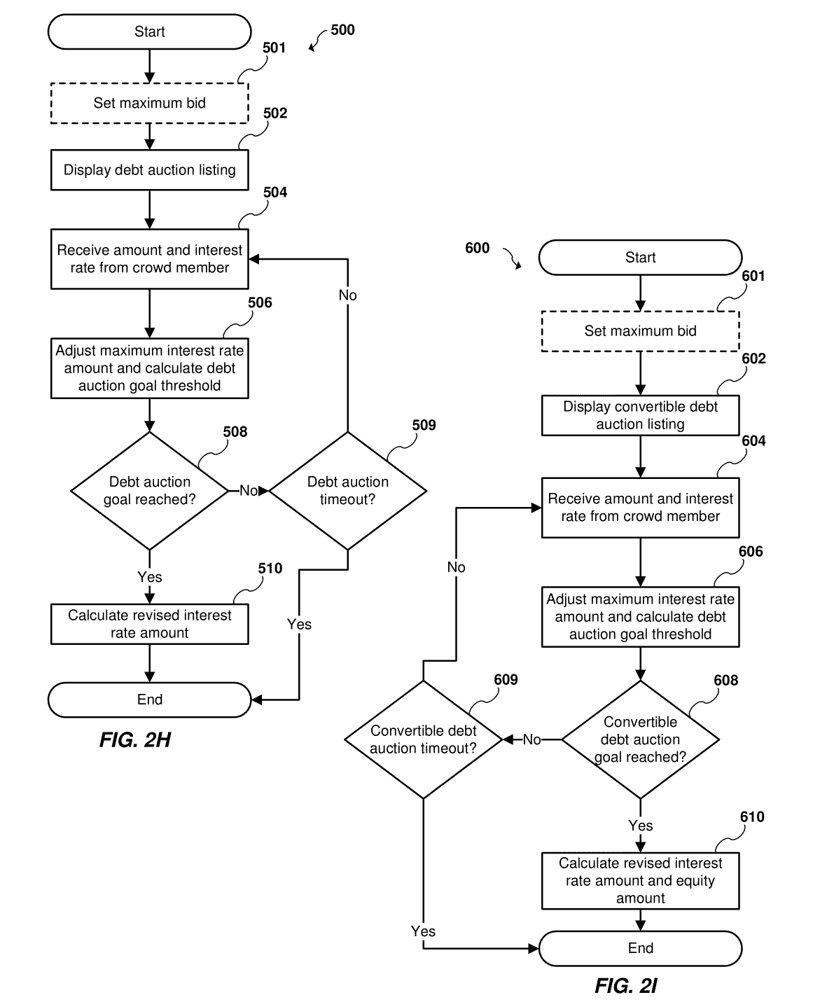

Referring to FIGS. 2A-2I, flow charts for managing crowdfunding in accordance with an embodiment of the present invention, are shown. According to one embodiment, a flow chart illustrating a business entity raising capital using the present invention is illustrated in FIGS. 2A and 2B. At block 152, a business entity desires to raise capital. If traditional means, such as a bank loan 152a, an angel investor 152b, venture capital 152c, or family and friends 152d, are not available and practical, then the present invention might be a suitable option. If the business entity is willing to give equity to inventors then the crowdfunding portal of the present invention is utilized, as shown at blocks 158 and 162. At block 164, a profile for the business entity is created on a website relating to the present invention (e.g., MassCatalyst.com). If the business entity instead needs a loan or debt financing then execution continues at block 164. At block 166, a determination is made as to the likelihood of funding success, and if Title II or Title III funding is required. A further determination is made as to whether the funding relates to equity financing, loan or debt financing, or convertible debt financing, at block 168.

If the funding relates to equity financing then execution continues at block 172. A background check and a business valuation of the business entity is performed at blocks 174 and 176, respectively. If any issues remain that are not resolvable, then execution exits. Otherwise, an online business entity profile page is made available by the present invention at block 180. The equity action is then started at block 182.

If the funding relates to convertible debt financing then execution continues at block 184. At block 186, a determination of the interest rate or loan amount available is made by a third party. A background check and a business valuation of the business entity is performed at blocks 188 and 190, respectively. If any issues remain that are not resolvable, then execution exits. Otherwise, an online business entity profile page is made available by the present invention at block 194. The debt action is then started at block 196.

If the funding relates to convertible debt financing then execution continues at block 198. At block 200, a determination of the interest rate or loan amount available is made by a third party. A background check and a business valuation of the business entity is performed at blocks 202 and 204, respectively. If any issues remain that are not resolvable, then execution exits. Otherwise, an online business entity profile page is made available by the present invention at block 208. The convertible debt action is then started at block 210.

According to one embodiment, flow charts for managing crowdfunding in accordance with an embodiment of the present invention, are shown at FIGS. 2C-2I. The present invention includes, without limitation, an information gathering and confirmation or process module 300, an equity auction module 400, a debt auction module 500, a convertible debt auction module 600, and an administrative module 700.

At block 312, a request is made to create an equity auction from an equity auction requester. The equity auction request is verified at block 314. At block 316, the requester is notified as to whether the equity auction request was accepted or rejected. Additional detail regarding the equity auction request is received and any notifications are sent to the requester at blocks 318 and 320. At block 326, a profile page associated with the equity action requester is posted the system of the present invention.

At block 362, a request is made to create a debt auction from a debt auction requester. The debt auction request is verified at block 364. At block 366, the requester is notified as to whether the debt auction request was accepted or rejected. Additional detail regarding the debt auction request is received and any notifications are sent to the requester at blocks 368 and 370. At block 372, a profile page associated with the equity action requester is posted the system of the present invention.

At block 382, a request is made to create a convertible debt auction from a convertible debt auction requester. The convertible debt auction request is verified at block 384. At block 386, the requester is notified as to whether the convertible debt auction request was accepted or rejected. Additional detail regarding the convertible debt auction request is received and any notifications are sent to the requester at blocks 388 and 390. At block 392, a profile page associated with the equity action requester is posted the system of the present invention.

At optional block 401, a minimum bid amount is determined and stored. Under other embodiments, there is no minimum bid amount. The equity auction listing is displayed at block 402. At block 404, the number of shares and the per share amount are received from a crowd member. The minimum per share amount is adjusted and the auction goal threshold is calculated at block 406. At blocks 408 and 409, if the equity auction goal has not been met and the equity auction timeout has not been reached, then execution continues at block 404. Otherwise, if the equity auction goal has been met, then the final per share amount is calculated at block 410.

At optional block 501, a maximum interest rate bid amount is determined and stored. Under other embodiments, there is no maximum interest rate bid amount. The debt auction listing is displayed at block 502. At block 504, the amount and interest rate bid are received from a crowd member. The maximum interest rate amount is adjusted and the auction goal threshold is calculated at block 506. At blocks 508 and 509, if the debt auction goal has not been met and the debt auction timeout has not been reached, then execution continues at block 504. Otherwise, if the debt auction goal has been met, then the final interest rate amount is calculated at block 510.

At optional block 601, a maximum interest rate bid amount is determined and stored. Under other embodiments, there is no maximum interest rate bid amount. A minimum bid amount may also be determined and stored. The convertible debt auction listing is displayed at block 602. At block 604, the amount interest rate bid are received from a crowd member. The number of shares may also be received. The maximum interest rate amount and the per share amount are adjusted and the auction goal threshold is calculated at block 606. At blocks 608 and 609, if the convertible debt auction goal has not been met and the convertible debt auction timeout has not been reached, then execution continues at block 604. Otherwise, if the convertible debt auction goal has been met, then the interest rate and the final per share amount are calculated at block 610.

### Administrative Module

According to one embodiment, the system 100 includes an administration and configuration module 600 that is used by an administrator 103 to setup and configure the system 100. An administrator 103 may connect via a secure socket connection to configure the system 100. The administrator 103 can select what data, user interfaces and/or modules are to be presented to the one or more crowd members (101a-101n). User access and permissions database 128 may include, without limitation, user name, user identification (ID), password, profile, permission, and the like. The system 100 receives setup and configuration information.

Such setup and configuration information may include without limitation branding information, user options, files, images, users and permissions information, and the like. The setup and configuration information also include, without limitation, information provided by the one or more crowd members (101a-101n), one or more equity, debt or convertible debt givers (102a-102n), one or more equity, debt or convertible debt recipients (104a-104n).

### III. Exemplary User Interfaces

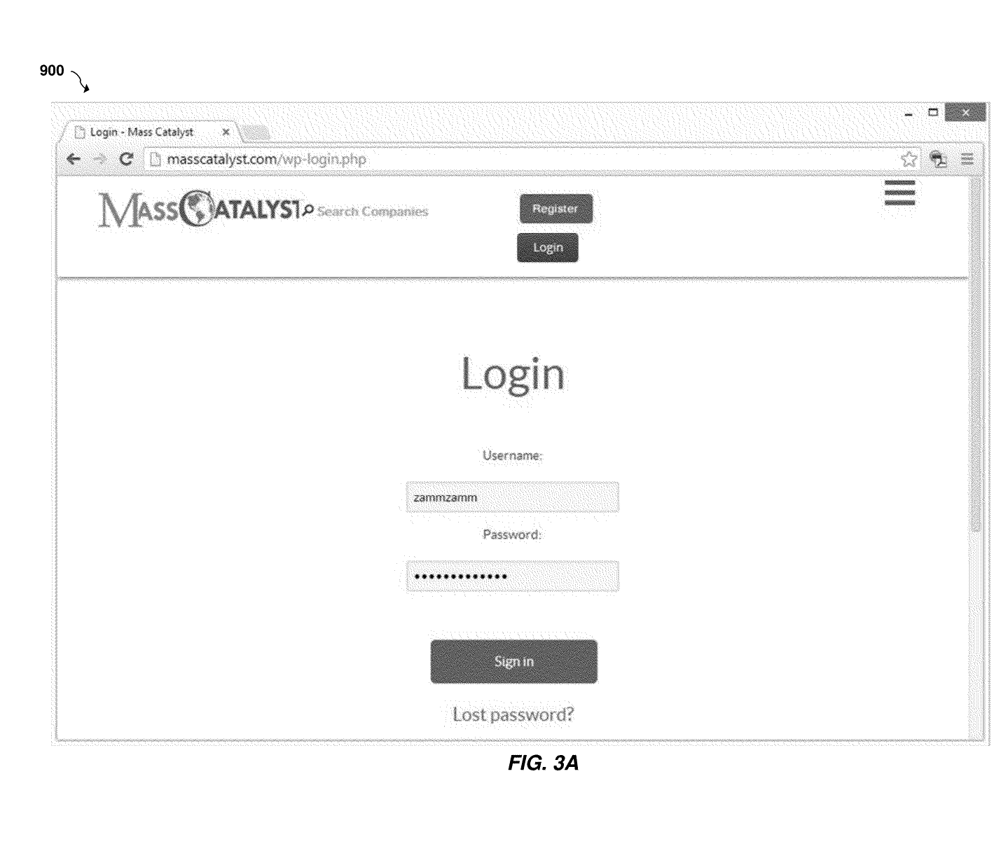

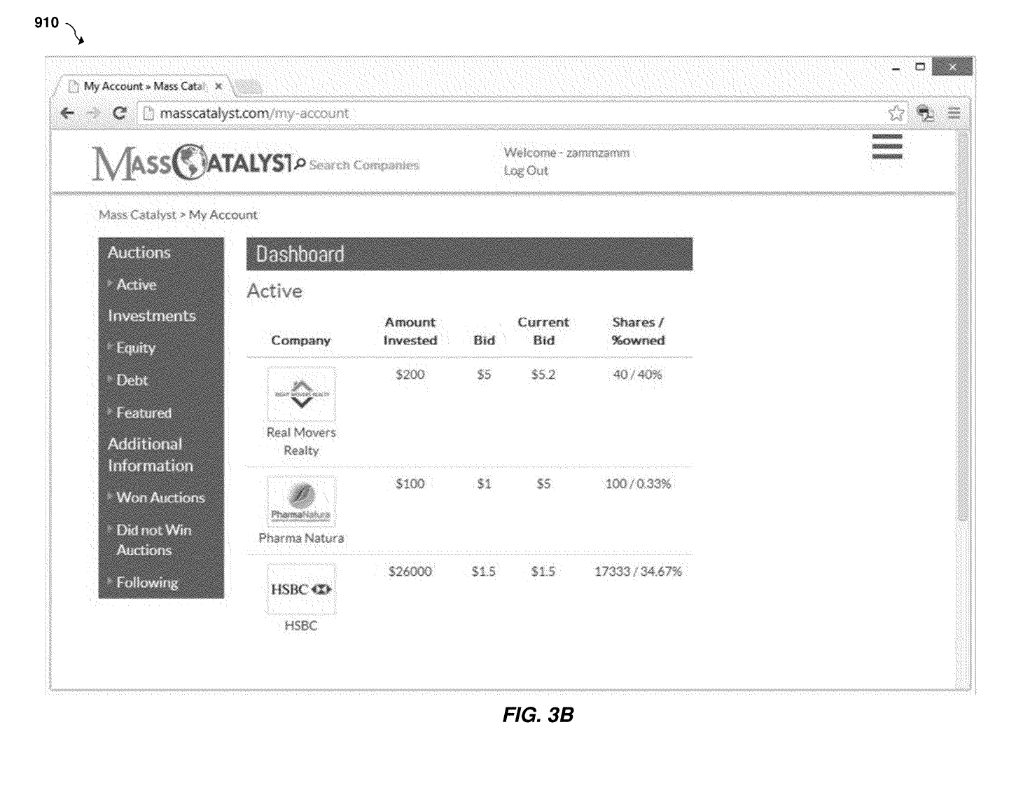

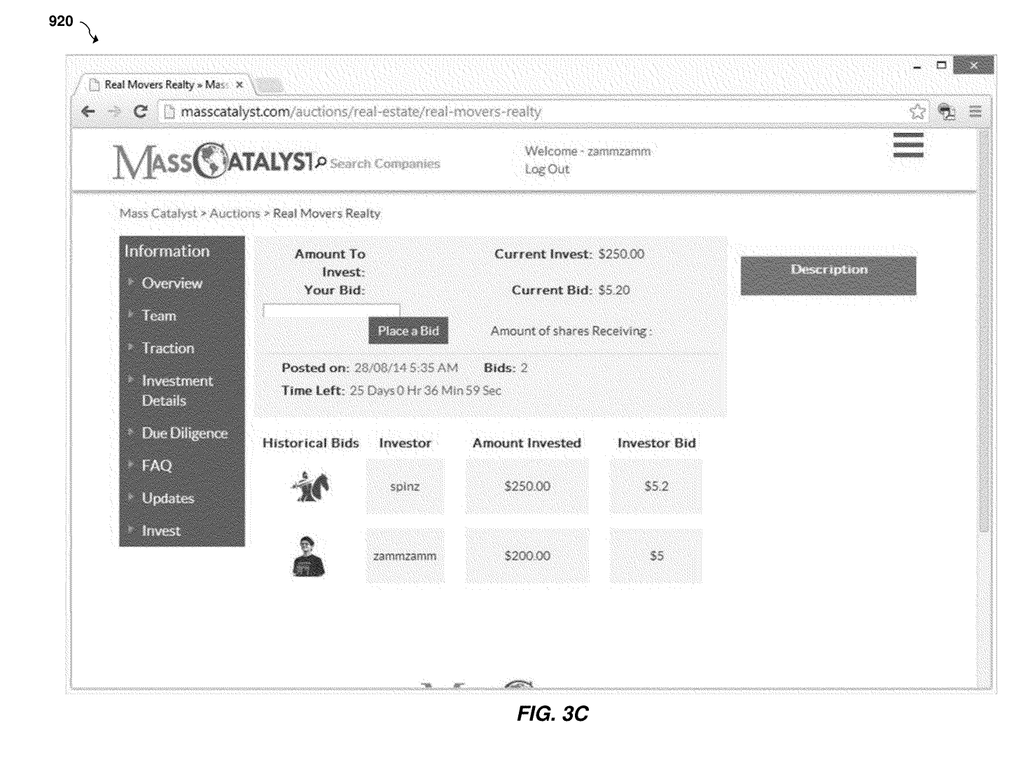

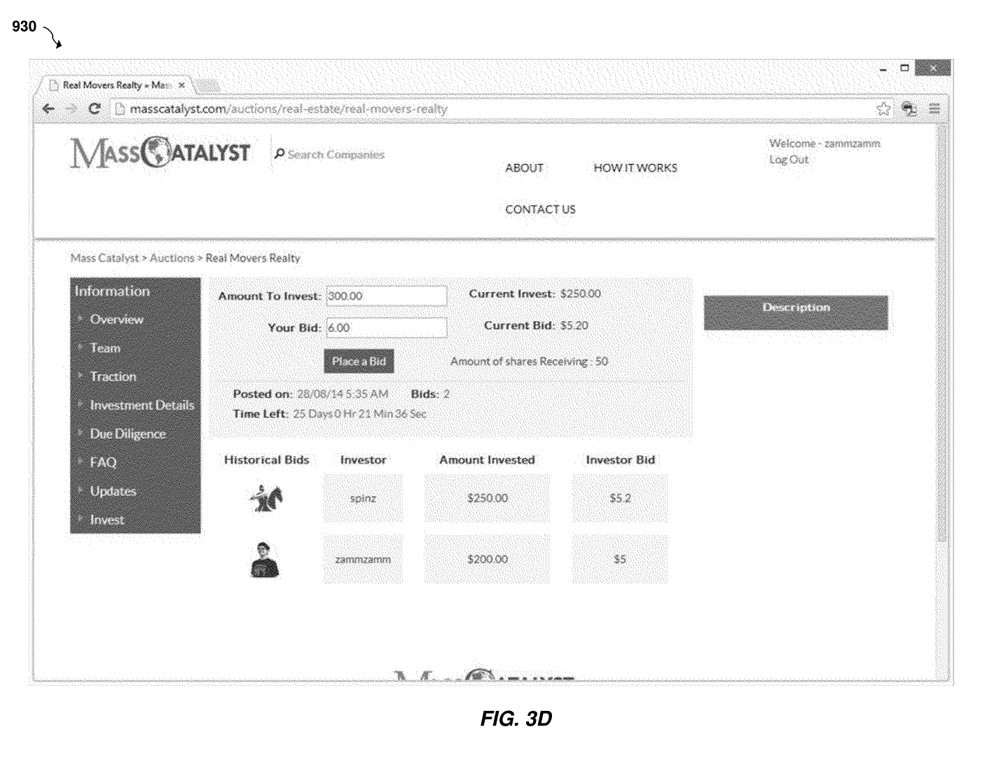

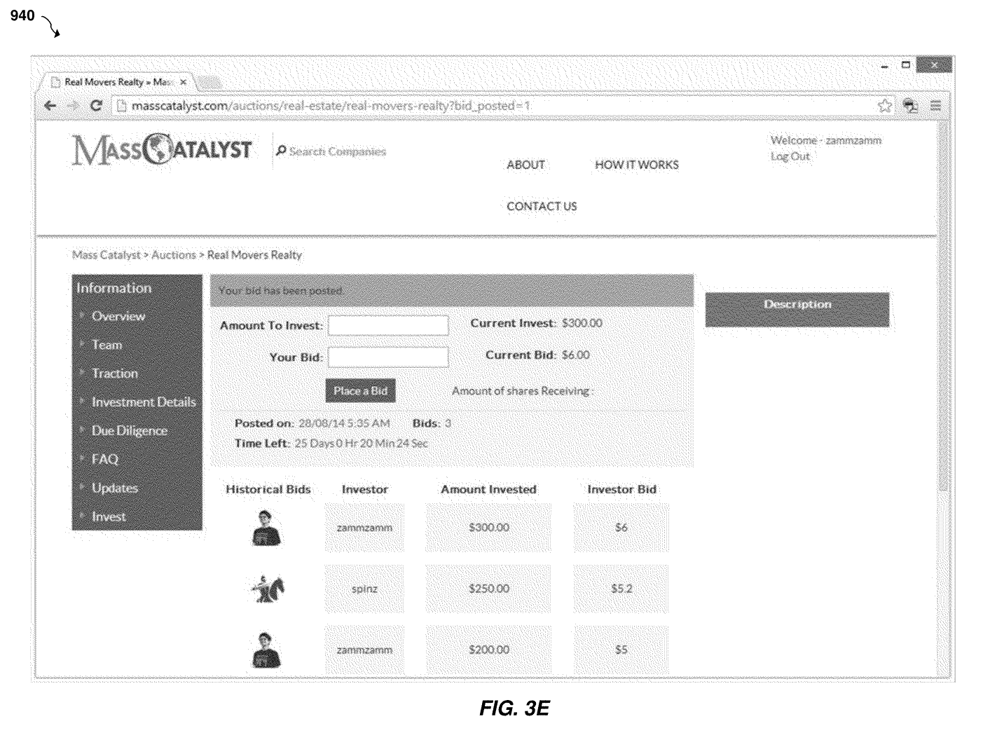

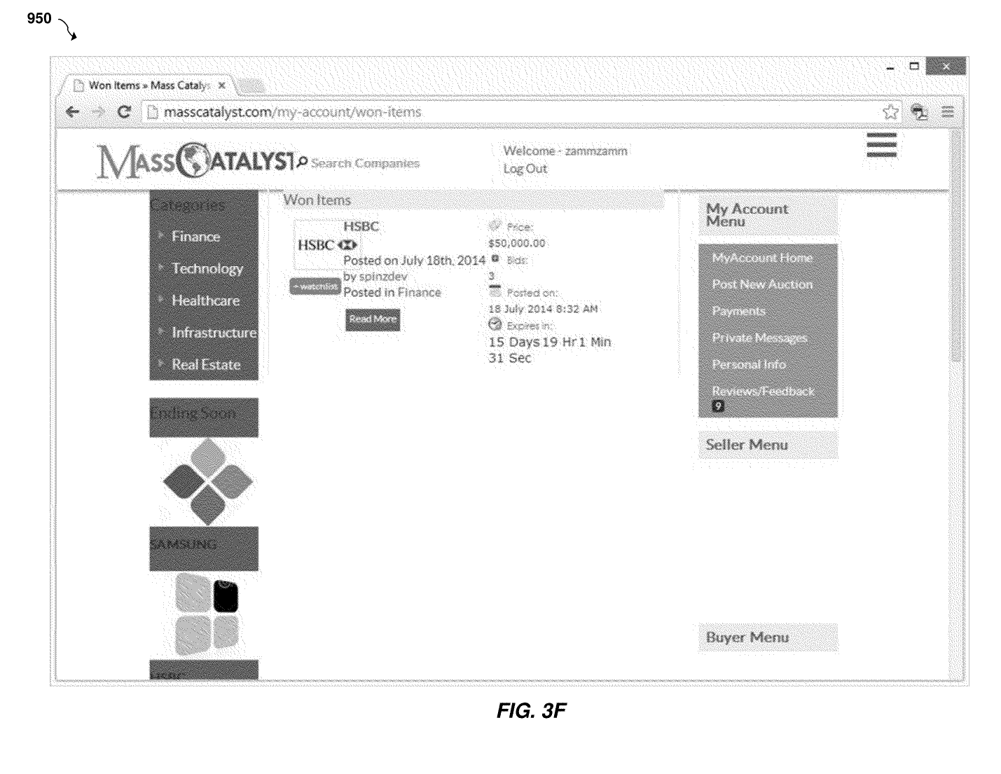

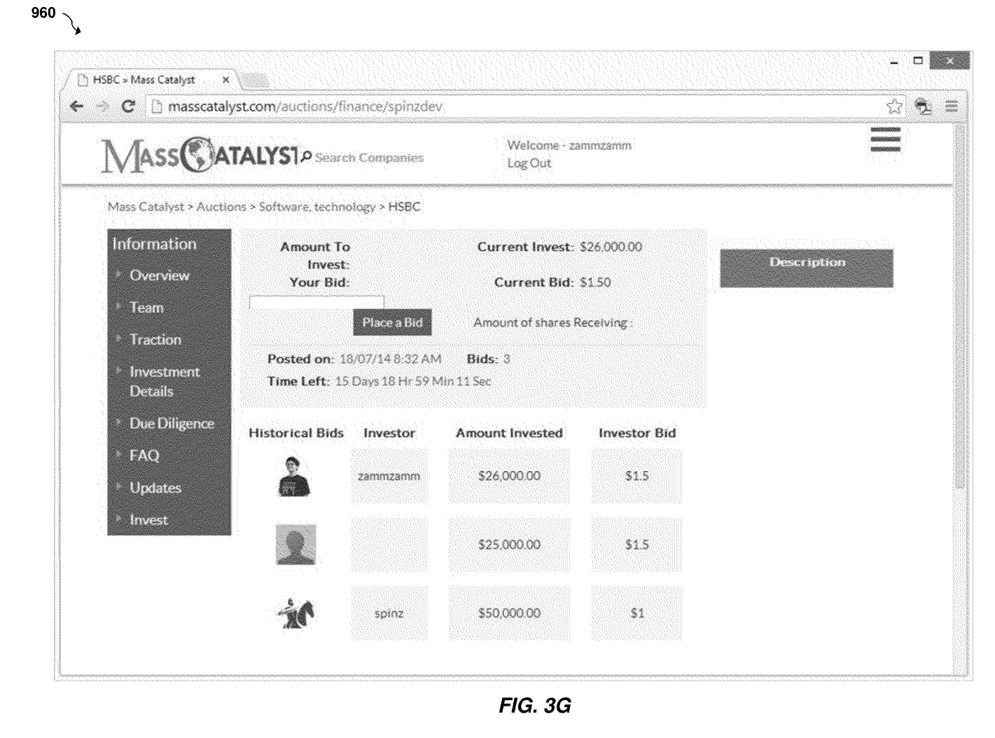

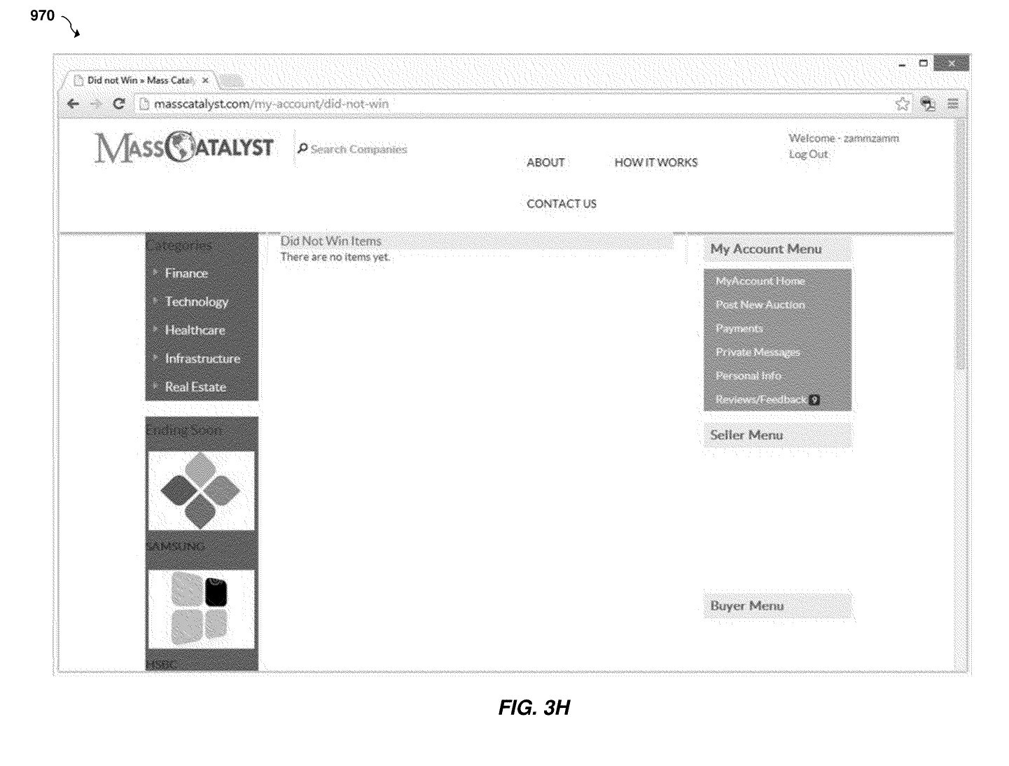

FIGS. 3A-3H illustrate exemplary user interfaces for managing crowd funding in accordance with an embodiment of the present invention. It is understood that other user interfaces are possible within the scope of the invention and that the graphical user interfaces shown are not intended to be limiting to the present invention. According to one embodiment, when an administrator 103 logs into the system 100, the administrator 103 is presented with a graphical user interface that allows the administrator 103 to configure the system 100.

According to one embodiment, when a crowd member 101 logs into the system 100, the crowd member 101 is presented with graphical user interfaces similar to the exemplary graphical user interfaces shown in FIGS. 3A-3H. The graphical user interfaces include active auctions; equity, debt and featured investments; won auctions; and not won auctions. An exemplary listing of active auctions is shown in FIG. 3B. Selecting any of the active auction listings displays a graphical user interface such as the exemplary ones shown in FIGS. 3C-3D. Using these interfaces, a potential investor may bid on a particular listing, which results in a new bid entry as shown respectively in FIGS. 3D and 3E. Clearly other graphical user interfaces and functionality is within the scope of the present invention.

### IV. Other Modifications And Variations

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, device, or computer program product. Accordingly, the present invention may take the form of an entirely hardware embodiment or an embodiment combining software and hardware aspects all generally referred to herein as a “circuit” or “module.”

The present invention thus includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in an object oriented programming language such as Java®, Smalltalk, C# or C++. However, the computer program code for carrying out operations of the present invention may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A system for managing crowd funding, the system comprising:
a plurality of remote computers respectively operated by a plurality of users;
a central server;
a network interface in communication with the central server and the plurality of remote computers over a network, the network interface being configured to provide crowd related funding;
a shared database in communication with the central server;
wherein the central server is configured to:
receive and verify a request for a plurality of crowd related funding;
store the information for each of the plurality of crowd related funding in the shared database;
provide a listing for each of the plurality of crowd related funding from the shared database on at least one of the plurality of remote computers;
receive one or more funding bids for at least one of the plurality of crowd related funding from one or more crowd members during a predefined period; and
calculate a funding amount based on the one or more funding bids.

2. The system of claim 1, the central server being further configured to:
receive one or more equity share bids for at least one of the plurality of crowd related funding from one or more crowd members during a predefined period; and
calculate a funding amount based on the one or more equity share bids.

3. The system of claim 1, the central server being further configured to:
receive one or more interest rate bids for at least one of the plurality of crowd related funding from one or more crowd members during a predefined period; and
calculate a funding amount based on the one or more interest rate bids.

4. A computer program product embodied on a non-transitory computer readable medium for managing crowd funding, wherein the computer program is implemented by one or more processors executing processor instructions, the computer program product comprising:
a first computer code for receiving and verifying on a central server a request for a plurality of crowd related funding;
a second computer code for storing the information for each of the plurality of crowd related funding in a shared database in communication with the central server;
a third computer code for providing a listing for each of the plurality of crowd related funding from the shared database on at least one of a plurality of remote computers respectively operated by a plurality of users;
a fourth computer code for receiving one or more funding bids for at least one of the plurality of crowd related funding from one or more crowd members during a predefined period; and
a fifth computer code for calculating a funding amount based on the one or more funding bids.

5. The computer program product of claim 4, the computer program product further comprising:
a sixth computer code for receiving one or more equity share bids for at least one of the plurality of crowd related funding from one or more crowd members during a predefined period; and
a seventh computer code for calculating a funding amount based on the one or more equity share bids.

6. The computer program product of claim 4, the computer program product further comprising:
a sixth computer code for receiving one or more interest rate bids for at least one of the plurality of crowd related funding from one or more crowd members during a predefined period; and
a seventh computer code for receiving a funding amount based on the one or more interest rate bids.
